(19) United States
(12) Patent Application Publication
(10) Pub. No.: US 2003/0087639 A1
(43) Pub. Date: May 8, 2003

(54) Methods and apparatus for international cellular telephone calls

(76) Inventor: Zvi Barak, Ra-anana (IL)

Correspondence Address: David P. Gordon, Esq., 65 Woods End Road, Stamford, CT, 06905, US

(21) Appl. No.: 09/994,029

(22) Filed: Nov. 6, 2001

(51) Int. Cl. H04Q 7/20

(52) U.S. Cl. 455/445; 455/406

(57) ABSTRACT

Methods for international cellular calls include purchasing cellular telephones in bulk in a destination country, taking them to an origin country for rental to travelers to the destination country, providing dedicated switching equipment in both the origin and destination countries, and programming the cell phones and the switching equipment to direct calls between the origin and destination countries through the dedicated switching equipment. The apparatus of the invention includes the cell phones, the switching equipment, and the communication link(s) between the origin and destination countries. According to the presently preferred embodiment, the dedicated switching equipment and the cell phones are owned by the same company or related companies. The communications link(s) between the origin and destination countries is (are) preferably leased from another company.

### BACKGROUND OF THE INVENTION

1. Field of the Invention

The invention relates to telecommunications. More particularly, the invention relates to international cellular telecommunications.

2. State of the Art

To many people, cellular telephones have become a necessity. Business people who travel frequently rely on cellular telephones to keep in touch with colleagues and clients. The cellular telephone networks throughout the civilized world work quite well. However, if a traveller brings a cellular telephone from one country to another, problems may arise. In many cases, a cellular telephone which was activated in one country will not operate at all in another country. In other cases, the telephone will operate but not economically as international “roaming” charges are often quite high.

One of the solutions to the problems of international cellular telecommunications is to rent a local cell phone when visiting a foreign country. These phones are often offered for rent at car rental agencies. However, the per minute cost of operating these rented cell phones is up to ten times the per minute charge usually paid for regular cell phone service. In addition, these rental phones have a phone number local to the country in which they are rented. Thus, a call to or from a rental phone to the home country of the renter will often involve an expensive international calling rate. Further, the renter will not know what the phone number is until the phone is rented. Therefore, the new cell phone number must be circulated to all of the renter's colleagues and clients if the renter is to be reachable.

### SUMMARY OF THE INVENTION

It is therefore an object of the invention to provide methods and apparatus for international cellular telephone calls.

It is also an object of the invention to provide methods and apparatus for international cellular telephone calls which allow a caller to travel to another country and obtain economical cellular telephone service.

It is another object of the invention to provide methods and apparatus for international cellular telephone calls which allow the cell phone user to keep the same phone number when traveling in other countries.

It is still another object of the invention to provide methods and apparatus for international cellular telephone calls which operate transparently to the callers.

In accord with these objects which will be discussed in detail below, the methods of the present invention include obtaining cellular telephones numbers in bulk associated with a cellular telephone service in a destination country, providing cellular phones which have been programmed with the telephone numbers to travelers from an origin to the destination country, providing dedicated switching equipment in the destination country, and programming the cell phones and the switching equipment to direct calls to the origin country from the destination country through the dedicated switching equipment. Optionally, dedicated switching equipment is provided in the origin country and all calls from the origin country to the destination country are routed through the dedicated switching equipment in the origin country. The apparatus of the invention includes the cell phones, the switching equipment, and the communication link(s) between the origin and destination countries. According to the presently preferred embodiment, the dedicated switching equipment and the cell phones are owned by the same company or related companies. The communications link(s) between the origin and destination countries is (are) preferably leased from another company.

In order to allow the user to maintain the same phone number while traveling in a foreign country (i.e. the destination country), one method of the invention include forwarding calls destined for the user's local phone number to the dedicated switching equipment in the origin country and programming the dedicated switching equipment to forward these calls to the number of the cell phone the user rented. Alternatively, methods of the invention allow for forwarding calls to the user's local phone number directly to the rented cell phone or assigning a new local number for forwarding calls to the rented cell phone. In cases where the local phone number is a cell phone number, the local cell phone company provides the means for forwarding or redirecting to the rented phone or to the dedicated switching equipment. In cases where the local phone number is a wireline phone number, the local PSTN provides the means for forwarding or redirecting to the rented phone or to the dedicated switching equipment. Different methods of forwarding/redirecting are disclosed.

According to presently preferred aspects of the invention, local calls in the destination country are processed by switches of the local cell phone company but international calls are processed by the dedicated switching equipment in the destination country. The cell phones and/or the accounts associated with the cell phones are preferably programmed to direct all international calls, i.e. all phone numbers starting with an international dialing code, e.g. zero, to the dedicated switching equipment in the U.S. Alternatively, the phones are programmed to speed dial to the dedicated switching equipment for making international calls. Billing international calls to a rented phone is preferably effected using Caller ID. According to a presently preferred embodiment, the dedicated switching equipment is signalled when a phone is rented that the phone is “active” and is signalled when a phone is returned that the phone is “inactive”.

Additional objects and advantages of the invention will become apparent to those skilled in the art upon reference to the detailed description taken in conjunction with the provided figures.

### BRIEF DESCRIPTION OF THE DRAWINGS

FIG. 1 is a simplified flow chart illustrating the methods of the invention; and

FIG. 2 is a schematic illustration of the distribution of the apparatus of the invention.

### DETAILED DESCRIPTION OF THE PREFERRED EMBODIMENTS

The invention is described herein with the destination country being the United States and the origin country being some other country. It will be appreciated, however, that the methods of the invention could be applied to any two countries. In addition, for purposes herein, the terms “international” and “outside the U.S.” are intended to mean places where a country code must be dialed to effect calls to/from the U.S.

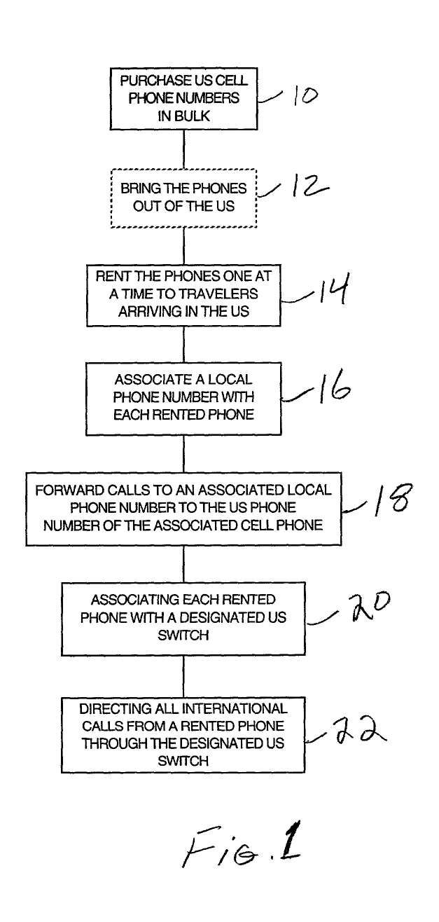

Turning now to FIG. 1, a method according to the present invention includes purchasing U.S. cellular telephone numbers in bulk from a U.S. cell phone company as illustrated at 10 in FIG. 1. According to the invention, the actual phones need not be purchased or programmed in the U.S. All that is required is that the phones be associated with a valid U.S. cell phone telephone number. Preferably, an arrangement is made with the U.S. cell phone company that, when the phones are inactive, the monthly service charge will be minimal and the regular monthly service charge will be applied only if the phone is used. If actual phones are purchased in bulk in the U.S., they are optionally brought out of the U.S. to an origin country as illustrated in phantom at 12 in FIG. 1. Whether the phones are taken to the origin country or remain in the U.S., they are rented to people who are traveling from the origin country to the U.S. as indicated by 14 in FIG. 1. Preferably, though not necessarily, before leaving the origin country, a phone number local to the origin country is associated with the rented phone as indicated at 16 in FIG. 1. This local number may be the local cell phone number, home phone number, office phone number, etc. (or all of those numbers) of the person renting the phone or a “new” local number assigned at the time of rental. After the local number is associated with the rented cell phone, all calls to this local number are forwarded to the rented phone's U.S. phone number as indicated at 18 in FIG. 1. According to the presently preferred embodiment, one or more designated switches in the U.S. are associated with the rented phones as indicated at 20 in FIG. 1. All international calls from the rented phone are preferably routed through this designated switch as shown by 22 in FIG. 1.

According to one embodiment of the invention, the step of associating a local phone number with the rented phone (step 16 in FIG. 1) is effected by the process of forwarding all calls received by the local number(s) directly to the phone number of the rented phone using the local telephone company equipment. According to a first alternate embodiment, this step is effected by the process of forwarding all calls received by the local number(s) to dedicated switching equipment in the origin country which forwards the call to the rented cell phone. For the first alternate embodiment to work, the identity of the number from which the calls are forwarded must be provided to the dedicated switching equipment. According to a second alternate embodiment, a dedicated “new” local phone number is assigned. This new number is a DID (direct inward dial) number to the dedicated switching equipment which forwards the call to the rented cell phone. The renter has the local phone company forward all of his calls to this new DID dumber. According to a third alternate embodiment, The renter does not have calls forwarded to the DID number but instructs colleagues and clients to call him via the DID number. As another alternative, the renter can instruct colleagues and clients to call the U.S. phone number of the rented phone. The preferred embodiment will depend on the cost of calling the U.S. from the origin country and the availability of forwarding service in the origin country. If the service is available and the cost is acceptable, the calls will be forwarded to or directly dialed to the U.S. cell phone number. If the cost is not acceptable, the calls will be routed through dedicated switching equipment in the origin country.

In all of these embodiments, the step of associating the local phone number with the rented phone (“activating”) is performed when or before the renter picks up the phone. When the rented phone is returned, the local phone number is disassociated from the phone (“deactivated”).

Those skilled in the art will appreciate that the methods of the invention can be performed by providing the rental phones in the U.S. rather than in another country. Accordingly, the rental agreement and the assignment of a U.S. phone number may take place outside the U.S., with the delivery of the cell phone occurring in the U.S., e.g., at an airport of arrival. Moreover, the rental agreement, the assignment of a U.S. phone number, and the delivery of the cell phone may all take place within the U.S. In this situation, a mechanism must be provided to associate the phone number local to the origin country with the U.S. cell phone number. By way of example, the cell phone user may call a customer service center, or make a call to the origin country to program the phone number local to the origin country to forward calls to the U.S. cell phone, or call the dedicated switch in the U.S. or origin country and, through interactive response, request that the switch call the telephone company in the origin country and setup the call forwarding.

According to presently preferred aspects of the invention, local calls in the U.S. are processed by switches of the local cell phone companies but international calls are processed by the dedicated switching equipment in the U.S. The cell phones are preferably programmed to speed dial to the dedicated switching equipment for making international calls. Billing international calls to a rented phone is preferably effected using Caller ID. According to a presently preferred embodiment, the dedicated switching equipment is signalled when a phone is rented that the phone is “active” and is signalled when a phone is returned that the phone is “inactive”.

Depending on the international toll rates of the origin country, calls from the origin country to the rented U.S. cell phone may be carried by the public network. Alternatively, calls from the origin country to the rented U.S. cell phone are carried by a private network between the dedicated switching equipment in the origin country and in the U.S.

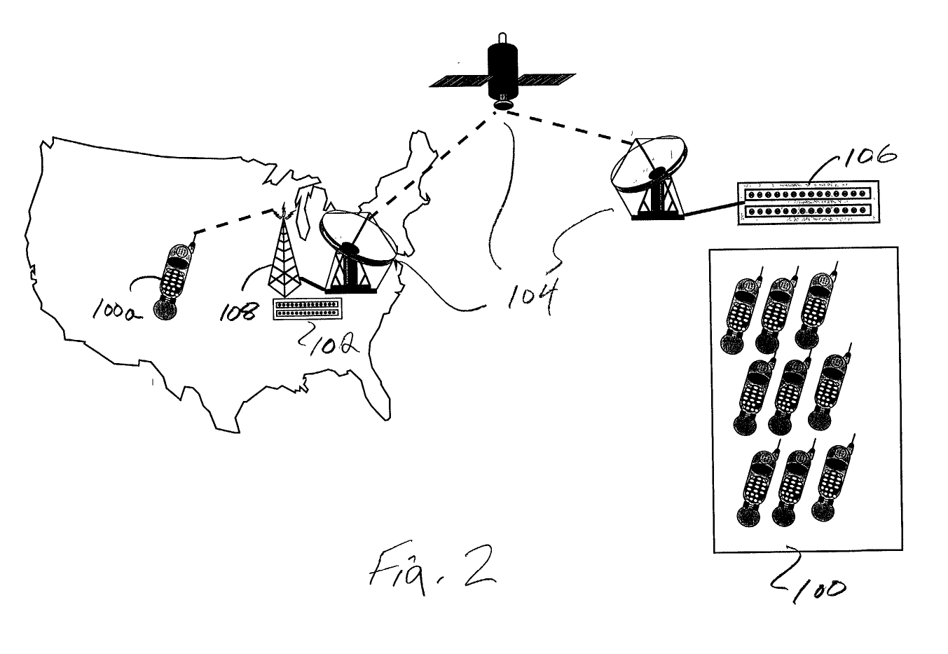

Referring now to FIG. 2, the apparatus of the invention includes the cell phones 100 which were purchased in bulk from a U.S. cell phone company, taken outside the U.S., rented outside the U.S. and carried back to the U.S. as shown by numeral 100a. The apparatus also includes dedicated switching equipment 102 in the U.S., communication links 104 to the origin country, and optionally, dedicated switching equipment 106 in the origin country. As shown in FIG. 2, the switching equipment 102 is coupled to the U.S. cell phone network. The optional switching equipment 106 is coupled to the PSTN (not shown) of the origin country. Both switching equipment 102 and 106 are coupled to the communication links 104.

According to the presently preferred embodiment, the dedicated switching equipment and the cell phones are owned by the same company, related companies, or associated companies. The communications link(s) between the U.S. and the origin country is (are) preferably leased from another company.

It will be appreciated that the dedicated switch may be part of the cell phone network and leased by the owner of the rental cell phones. In addition, the cell network may be configured such that calls between rental phones are free. Moreover, calls to the dedicated switch can be free of airtime charges. It will also be appreciated that the dedicated switch can be configured to provide services such as voice mail, call screening/blocking, conference calling etc. According to the invention, voice mail which is not retrieved before the rental phone is returned may be forwarded to the voice mail system of the renter in the country of origin.

There have been described and illustrated herein several embodiments of methods and apparatus for international cellular telephone calls. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as so claimed.

1. A method for providing cellular telephone service in the U.S. to and/or from outside the U.S., said method comprising:
a) bringing into the U.S. a phone programmed with one of a plurality of U.S. cell phone numbers which were obtained in bulk;
b) providing dedicated switching equipment in the U.S.; and
c) routing all international calls from the phone brought into the U.S. through the dedicated switching equipment.

2. A method according to claim 1, further comprising:
d) routing all domestic calls to/from the phone brought into the U.S. through the existing U.S. cell phone network.

3. A method according to claim 1, wherein:
said step of routing includes programming the phone to speed dial the dedicated switching equipment.

4. A method according to claim 1, wherein:
said step of routing includes routing all calls to numbers that start with zero.

5. A method according to claim 1, further comprising:
d) creating billing information based on Caller ID data acquired at the dedicated switching equipment.

6. A method according to claim 1, further comprising:
d) notifying the dedicated switching equipment when the phone is brought into the U.S.

7. A method according to claim 6, further comprising:
e) notifying the dedicated switching equipment when the phone is taken out of the U.S.

8. A method according to claim 1, further comprising:
d) associating a non-U.S. telephone number with the phone number of the phone brought into the U.S.; and
e) forwarding calls to the non-U.S. phone number to the phone number of the phone brought into the U.S.

9. A method according to claim 8, further comprising:
f) providing dedicated switching equipment outside the U.S., wherein
said step of forwarding includes routing calls through the dedicated switching equipment outside the U.S.

10. A method according to claim 1, wherein:
said step of obtaining U.S. cellular telephone numbers in bulk is performed by a first entity,
said step of bringing into the U.S. a phone programmed with one of the numbers which were purchased in bulk is performed by a second entity, and
said step of providing dedicated switching equipment in the U.S. is performed by a third entity.

11. A method according to claim 10, wherein:
said second entity is the customer of said first entity.

12. A method according to claim 1, further comprising:
d) obtaining the plurality of U.S. cell phone numbers in bulk

13. A method according to claim 1, wherein:
said phone is a part of a bulk purchase of phones.

14. A method of providing cellular telephone service in the U.S. to and/or from outside the U.S., said method comprising:
a) providing a cellular telephone to a traveler from outside the U.S., the cellular telephone programmed with a U.S. cell phone number; and
b) calling a dedicated switch in the U.S., said switch adapted to communicate with a telephone company outside the U.S. to effect forwarding of telephone calls from a non-U.S. telephone number to the U.S. cell phone number.

15. An apparatus for providing cellular telephone service in the U.S. to and/or from outside the U.S., said apparatus comprising:
a) a cellular phone programmed with one of a plurality of U.S. cell phone numbers which were purchased in bulk;
b) dedicated switching equipment in the U.S.; and
c) means for routing all international calls to/from the phoned brought into the U.S. through the dedicated switching equipment.

16. An apparatus according to claim 15, further comprising:
d) means for routing all domestic calls to/from the cellular phone through the existing U.S. cell phone network.

17. An apparatus according to claim 15, further comprising:
d) means for associating a non-U.S. telephone number with the phone number of the phone brought into the U.S.; and
e) means for forwarding calls to the non-U.S. phone number to the phone number of the phone brought into the U.S.

18. A method for providing cellular telephone service in the U.S. to and/or from outside the U.S., said method comprising:
a) providing a dedicated switch in the U.S. for carrying calls to outside the U.S.; and
b) providing a cell phone pre-programmed to direct all international calls through the dedicated switch.

19. A method for providing cellular telephone service in the U.S. to and/or from outside the U.S., said method comprising:
a) providing a dedicated switch in the U.S. for carrying calls to outside the U.S.;
b) providing a cell phone with a U.S. phone number;
c) automatically routing all international from the cell phone through the dedicated switch; and
d) automatically routing all domestic calls to/from the cell phone through the U.S. cell phone network.

20. A method for providing international cellular telephone service in the U.S., said method comprising:
a) providing a cell phone with a U.S. phone number; and
b) receiving at the cell phone with the U.S. phone number a call destined for a cell phone with a non-U.S. number.

21. A method according to claim 20, wherein:
said providing includes renting the cell phone to a traveler to the U.S. from a foreign country.
